(19) United States
(12) Patent Application Publication
(10) Pub. No.: US 2015/0204107 A1
(43) Pub. Date: Jul. 23, 2015

(54) DOOR STRIKE PLATE

(71) Applicant: EASY LATCH LLC, Chesapeake, VA (US)

(72) Inventor: Jonathan David SWEETEN, Chesapeake, VA (US)

(73) Assignee: EASY LATCH LLC, Chesapeake, VA (US)

(21) Appl. No.: 14/598,722

(22) Filed: Jan. 16, 2015

Related U.S. Application Data
(60) Provisional application No. 61/929,637, filed on Jan. 21, 2014.

(51) Int. Cl. E05B 15/02

(52) U.S. Cl. CPC E05B 15/0205

(57) ABSTRACT

An apparatus for receiving a door latch bolt may be shown and described. The apparatus can include a plate formed as a door strike plate, the plate having a cutout formed inside the plate. The cutout formed inside the plate can have a back side, a curved top side with a first distal end, a curved bottom side with a second distal end, and a curved front side terminating in at a top portion with the first distal end and at a bottom portion with the second distal end. Additionally, the plate can have one or more screw holes disposed on the plate and a curved front side.

### RELATED APPLICATIONS

This application claims priority to U.S. Provisional Application No. 61/929,637 filed Jan. 21, 2014, the disclosure of which is incorporated by reference herein in its entirety.

### BACKGROUND

Modern residential doors are typically equipped with bored cylindrical or tubular chassis lockset systems, which utilize a strike plate component. Strike plates are mounted on a door frame, receive the latch bolts mounted to the door knob assembly and allow doors to close and latch in a secure fashion. This prevents undesired movement of a door and allows for other devices, such as door locks, to be utilized to provide further security. If a door is not able to be closed and secured properly, a loss of security, privacy and home value can occur.

However, as doors are used and routinely opened or closed, various components of the door can wear out or fatigue. Doorknob assemblies and door hinges experience mechanical wear that may cause misalignment of a door latch bolt with the strike plate, preventing proper securing of the door. Door latch bolts can change position over time, preventing a secure closure of the door. A door latch bolt may become misaligned with the strike plate due to compression or expansion of a door frame over time, typically caused by house settling and temperature variation. Additionally, doors themselves often compress or expand over time, leaving a latch in a position where it no longer can be seated and secured in a strike plate. Door hardware upgrades, door mounted hooks, and weather stripping replacement can also lead to misalignments. Misalignments of a door latch with a door strike plate by as little as a fraction of a millimeter can prevent a door from latching or securing properly. Thus, when any of these conditions occurs, expensive repairs or replacement of the door latch, door knob assembly, or entire door itself are often necessary. Such solutions are often time consuming, complex, and difficult to plan for many homeowners. Further, such repairs may only be effective as short term solutions and often fail at unexpected or undesired times.

### SUMMARY

In an exemplary embodiment, an apparatus for assisting in closing and securing a door may be described. The apparatus can include a plate formed as a door strike plate, the plate having a cutout formed inside the plate. The cutout formed inside the plate can have a back side, a curved top side with a first distal end, a curved bottom side with a second distal end, and a curved front side terminating at a top portion with the first distal end and at a bottom portion with a second distal end. Additionally, the plate can have one or more screw holes disposed on the plate.

### BRIEF DESCRIPTION OF THE FIGURES

Advantages of embodiments of the present invention will be apparent from the following detailed description of the exemplary embodiments. The following detailed description should be considered in conjunction with the accompanying figures in which:

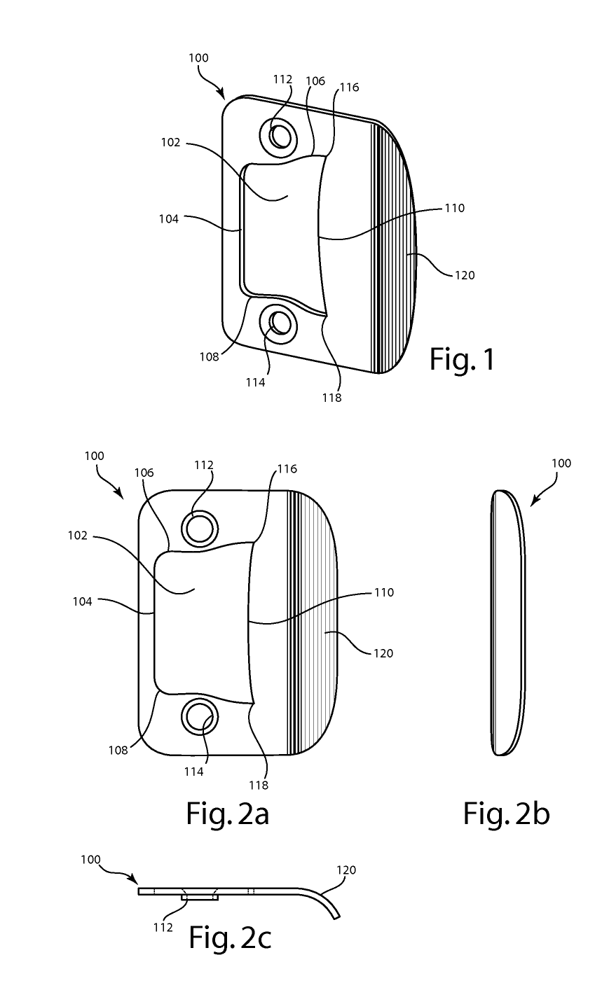

Exemplary FIG. 1 shows a perspective view of an exemplary door strike plate.

Exemplary FIG. 2a shows a top-down view of a door strike plate.

Exemplary FIG. 2b shows a first rotated view of a door strike plate.

Exemplary FIG. 2c shows a second rotated view of a door strike plate.

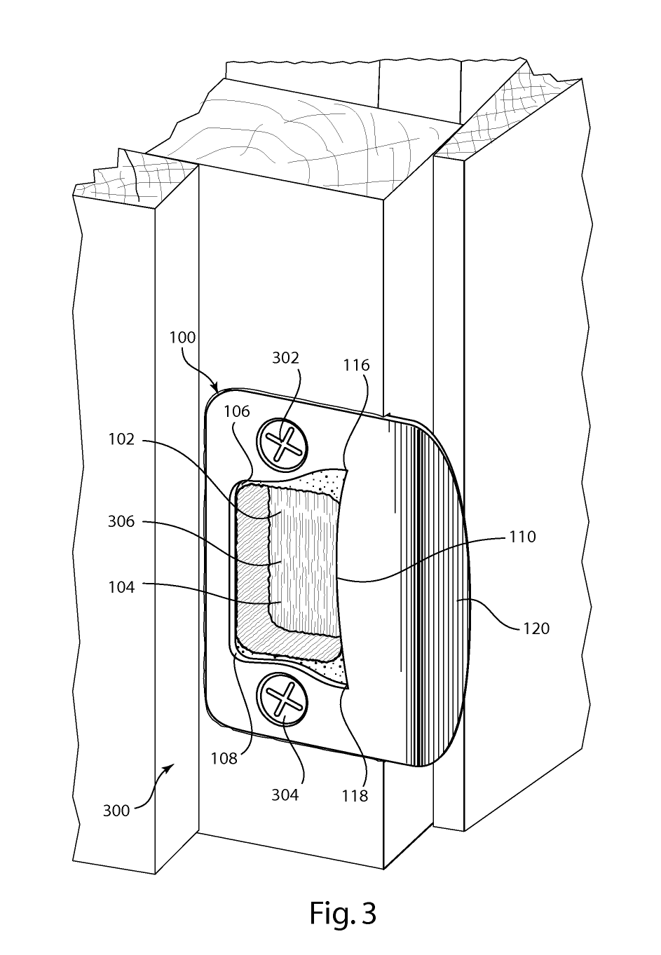

Exemplary FIG. 3 shows a door strike plate mounted on a door frame.

### DETAILED DESCRIPTION

Aspects of the invention are disclosed in the following description and related drawings directed to specific embodiments of the invention. Alternate embodiments may be devised without departing from the spirit or the scope of the invention. Additionally, well-known elements of exemplary embodiments of the invention will not be described in detail or will be omitted so as not to obscure the relevant details of the invention. Further, to facilitate an understanding of the description, discussion of several terms used herein follows.

As used herein, the word “exemplary” means “serving as an example, instance or illustration.” The embodiments described herein are not limiting, but rather are exemplary only. It should be understood that the described embodiments are not necessarily to be construed as preferred or advantageous over other embodiments. Moreover, the terms “embodiments of the invention”, “embodiments” or “invention” do not require that all embodiments of the invention include the discussed feature, advantage or mode of operation.

Generally referring to FIGS. 1-3, exemplary embodiments of a door strike plate may be shown and described. The door strike plate may be formed in a variety of manners and utilize any of a variety of materials. Additionally, the door strike plate may be such that it provides for an efficient replacement component that allows doors with misaligned latch bolts, doorknob assemblies, or other problems, to embed, latch and secure properly.

Referring now to exemplary FIG. 1 and exemplary FIGS. 2a, 2b, and 2c, a door strike plate may be shown. The door strike plate 100 may be formed out of any material, for example a metal, such sixteen gauge steel, or any other desired or known material or combination of materials. For example, the use of a substantially thick material, such as sixteen gauge or similar thickness (including fifteen gauge steel and fourteen gauge steel, by way of example), may provide an overall thickness of door strike plate that is greater than that of known door strike plates. Additionally, such a material may help a latch bolt to achieve a sufficient embed depth to securely seat in door strike plate 100 where a mortise recess or portion thereof may not exist underneath, and also provide further strength and durability to door strike plate 100, as well as maintaining strength and integrity under pressure

Door strike plate may have cutout 102, which may be disposed through the body of door strike plate 100. Cutout 102 may be formed in any desired or known fashion during manufacture. Cutout 102 may be formed in such a shape that it has a flat back side 104, a curved top side 106, a curved bottom top side 108, and curved front side 110. For example, curved top side 106 and curved bottom side 108 may be angled substantially towards a center portion of cutout 102 in their middle portions, and may extend down and away from a center portion of cutout 102 at distal ends 116 and 118, respectively. In other words, in some exemplary embodiments, curved top side 106 and curved bottom side 108 may have widths that increase from back side 104 to curved front side 110. The curves of curved top side 106 and curved bottom side 108 may substantially mirror each other in shape and increasing width from back to front. Also, in some further exemplary embodiments, curved front side 110 may also act as an expansion area that may be reshaped or adjusted to provide further size to opening of cutout 102, allowing for additional ease of fitting a previously-misaligned latch bolt.

Still referring to exemplary FIG. 1, door strike plate 100 may further include any desired attachment mechanism or capability, such as screw holes 112 and 114. Screw holes 112 and 114 may allow for door strike plate 100 to be securely attached or coupled to a door frame, or any other location, as desired. As above, the thickness of door strike plate 100 can also increase the thickness of screw holes 112 and 114, allowing for greater durability and strength.

Additionally, it may be appreciated that any coupling or attachment mechanisms may be utilized, as desired. Further, it may be appreciated that screw holes 112 and 114 may be formed in any shape and size. For example, screw holes 112 and 114 may be formed as oval shapes, or otherwise formed in a substantially oblong shape, or any other appropriate shape, which can allow for the mounting of door strike plate 100 in an adjustable fashion, for example vertically or horizontally. Such adjustable placement or movement of door strike plate 100 can allow for cutout 102 to securely seat and embed door latch bolts that are aligned or misaligned in the vertical or horizontal axis, or any combination thereof.

Also, as shown in exemplary FIG. 1, and further with respect to exemplary FIGS. 2b and 2c, door strike plate 100 may have curved front portion 120. Curved front portion 120 may be formed in any desired manner and may allow for a secure seating of door strike plate 100 against a door frame or any other desired location. As in previous exemplary embodiments, curved front portion may have a thickness to it that provides for additional strength and durability. However, it may be appreciated that curved front portion 120 may be formed with any desired thickness so as to be fitted or seated against a door frame in a desired fashion, for example flush with a door frame or cutout area on the door frame to provide desired functionality, strength, security, and aesthetics.

Referring now to exemplary FIGS. 1 and 2a, cutout 102 may be formed to have a variety of features and to allow for a variety of capabilities. For example, curved front side 110, terminating in distal ends 116 (top) and 118 (bottom), may accommodate a latch bolt of a doorknob assembly (not pictured) that could not be secured in a known door strike plate. The curvature of curved front side of door strike plate allows for cutout 102 to accommodate and securely seat a misaligned latch bolt from a doorknob assembly. For example, if a latch bolt of a doorknob assembly is skewed in any fashion, curved front side 110, along with curved top side 106 and curved bottom side 108 may allow for the skewed latch bolt to enter cutout 102 and be seated, allowing for a desired operation of the doorknob latch assembly. Such skewing may be caused by any of a variety of reasons, for example wear on the door or doorknob latch assembly. Wear on door hinges, or door frames warping out of square, commonly due to house settling, often causes door latch bolt misalignment and latch failure. Alternatively, a previously-fitted door strike plate or a new strike plate installed during a door hardware replacement may have been otherwise improperly attached, leading to misalignment with that door strike plate. The cutout 102 of door strike plate 100 therefore provides a greater area for the latch bolt so that if it is misaligned with a previous door strike plate, door strike plate 100 can receive and secure a latch bolt. In such examples, if a latch bolt strikes door strike plate 100 high or low, the latch bolt would still proceed to enter cutout 102 in the present example, whereas such placement would prevent a door from being closed and secured in other existing door strike plates. Additionally, if there are any items mounted on a door that can affect its typical, desired range of motion and position of the latch bolt, such as hooks commonly mounted at the top of a door or new or misaligned weather stripping, then door strike plate 100 can accommodate the change in position or displacement of a latch bolt caused by the hooks and provide a secure seating for the latch bolt in cutout 102.

Still referring to exemplary FIGS. 1 and 2a, a latch bolt striking high or low would be accommodated by door strike plate 100. As distal ends 116 and 118 provide upward and outward openings in cutout 102, a door latch bolt that is misaligned with a center portion of cutout 102 may still be securely seated in cutout 102. Further, in some exemplary embodiments, distal ends 116 and 118, as well as their surrounding areas, may act as or be referred to as one or more mortise cutout guides. In such exemplary embodiments door strike plate 100 may be mounted on a door frame or a cutout area on a door frame. Cutout 102 of door strike plate 100 may thus provide a wider opening, or open an area that is larger than a standard, known, rectangular mortise. A user can then mark the door frame, or otherwise use the shape of cutout 102, including distal ends 116 and 118 to act as a guide for expanding the mortise. This is shown in more detail in exemplary FIG. 3. However, it may further be appreciated that, even if a mortise is not expanded to reflect the size of cutout 102, a door latch bolt may still catch on the thickness of the metal and provide for a secure closing against curved front side 110 of cutout 102.

Referring now to exemplary FIG. 3, a door strike plate 100 may be shown as mounted against a door frame 300. Door strike plate may include all of the elements described in the various exemplary embodiments herein. Additionally, screws 302 and 304 may be used to secure door strike plate 100 to door frame 300. Further, mortise 306 is shown in a center portion of cutout 102, however mortise 306 is smaller than cutout 102. As described above, the elements of cutout 102 can thus be used as a guide to expand mortise 306. However, in some exemplary embodiments, mortise 306 may not be altered and a door latch bolt may securely embed and seat in cutout 102 and mortise 306. Alternatively, a door latch bolt may partially embed in mortise 306 but still securely seat or latch against curved front side 110 of cutout 102. Thus, door strike plate 100 can provide secure latching of a door using cutout 102 without a mortise 306 shaped substantially like cutout 102.

In still another exemplary embodiment, a method of using a door strike plate 100 may be described. In this method, an old door strike plate which does not allow for proper or desired latching may be removed and discarded. Door strike plate 100 may then be fitted to a door frame 300, for example as shown in FIG. 3. A pair of screws may then be used in screw holes 112 and 114 to secure door strike plate 100 to door frame 300. It may be appreciated in other exemplary methods that different attachment devices or compounds may be utilized. After door strike plate 100 is securely mounted, a door latch bolt that was previously misaligned may now function properly or as desired. Additionally, door strike plate 100 may be adjusted, for example vertically, so as to provide a proper receiving area in cutout 102 and mortise 306 for a door latch bolt. After door strike plate 100 is mounted and the fitment is evaluated with respect to mortise 306 and a door latch bolt, cutout 102 may also serve as a guide to expanding or changing the shape of mortise 306, as desired. In such exemplary embodiments, the door frame 300 and an area around mortise 306 may be marked, door strike plate 100 may be removed, and mortise 306 may be expanded, as desired. Door strike plate 100 may then be remounted on door frame 300, as desired.

The foregoing description and accompanying figures illustrate the principles, preferred embodiments and modes of operation of the invention. However, the invention should not be construed as being limited to the particular embodiments discussed above. Additional variations of the embodiments discussed above will be appreciated by those skilled in the art.

Therefore, the above-described embodiments should be regarded as illustrative rather than restrictive. Accordingly, it should be appreciated that variations to those embodiments can be made by those skilled in the art without departing from the scope of the invention as defined by the following claims.

What is claimed is:

1. An apparatus for receiving a door latch bolt, comprising:
a plate formed as a door strike plate, the plate having a cutout formed inside the plate, the cutout comprising:
a back side, a curved top side with a first distal end, a curved bottom side with a second distal end, and a curved front side terminating in at a top portion with the first distal end and at a bottom portion with the second distal end;
one or more screw holes disposed on the plate;
a top side;
a bottom side;
a rear side; and
a curved front side.

2. The apparatus for receiving a door latch bolt of claim 1, wherein the cutout is sized and shaped larger than a mortise on a door frame.

3. The apparatus for receiving a door latch bolt of claim 1, wherein the one or more screw holes are formed as ovals extending from the rear side of the door strike plate to the front curved side.

4. The apparatus for receiving a door latch bolt of claim 1, wherein the one or more screw holes are formed as ovals extending from the top side to the bottom side.

5. The apparatus for receiving a door latch bolt of claim 1, wherein the plate is formed of sixteen gauge steel.

6. The apparatus for receiving a door latch bolt of claim 1, wherein the wherein the curved top side of the cutout has a width that increases in the direction from the rear side of the cutout to the curved front side of the cutout.

7. The apparatus for receiving a door latch bolt of claim 1, wherein the wherein the curved bottom side of the cutout has a width that increases in the direction from the rear side of the cutout to the curved front side of the cutout.

8. The apparatus for receiving a door latch bolt of claim 1, wherein the curved front side of the cutout further comprises an expansion area.

9. A door latch assembly system for securely latching misaligned door latch bolts, comprising:
a door frame,
a door latch bolt mounted to a door;
a door strike plate mounted to the door frame and having a cutout, the cutout having a rear side, a curved front side, a curved top side with a top distal end, and a curved bottom side with a bottom distal end; and
a mortise disposed in the door frame about the cutout of the door strike plate, the mortise sized smaller than the cutout of the door strike plate;
wherein the door latch bolt mounted to the door is securely received by the cutout and securely latches in the door strike plate.

10. The door latch assembly system for securely latching misaligned door latch bolts of claim 9, wherein the top distal end of the curved top side, the bottom distal end of the curved bottom side, and the curved front side are guides for reshaping the mortise.

11. The door latch assembly system for securely latching misaligned door latch bolts of claim 9, wherein the cutout is a guide for reshaping the mortise.

12. The door latch assembly system for securely latching misaligned door latch bolts of claim 9, wherein the cutout is a guide for reshaping the mortise.

13. The door latch assembly system for securely latching misaligned door latch bolts of claim 9, wherein the wherein the curved top side of the cutout has a width that increases in the direction from the rear side of the cutout to the curved front side of the cutout.

14. The door latch assembly system for securely latching misaligned door latch bolts of claim 9, wherein the wherein the curved bottom side of the cutout has a width that increases in the direction from the rear side of the cutout to the curved front side of the cutout.

15. The door latch assembly system for securely latching misaligned door latch bolts of claim 9, wherein the curved front side of the cutout further comprises an expansion area.
